(19) United States
(12) Patent Application Publication
(10) Pub. No.: US 2011/0105691 A1
(43) Pub. Date: May 5, 2011

(54) Blends of Polypropylene and Polyethylene and Methods of Forming the Same

(75) Inventors: Michael McLeod, Kemah, TX (US); Jay Nguyen, Pasadena, TX (US); John Ashbaugh, Houston, TX (US)

(73) Assignee: Fina Technology, Inc., Houston, TX (US)

(21) Appl. No.: 12/611,520

(22) Filed: Nov. 3, 2009

(51) Int. Cl. C08L 23/06; C08L 23/12

(52) U.S. Cl. 525/240

(57) ABSTRACT

Polymer blends and methods of forming the same are described herein. The polymer blends generally include a single site transition metal catalyst formed polypropylene, a single site transition metal catalyst formed polyethylene and a polyethylene compatible nucleator.

### FIELD

Embodiments of the present invention generally relate to blends of incompatible polymers. Specifically, embodiments relate to blends of polypropylene and polyethylene having improved properties.

### BACKGROUND

Nucleation of homophasic polymers generally improves optical properties of the polymer, such as improved haze and clarity. However, nucleation of heterophasic polymers has not generally improved such optical properties.

Accordingly, it is desired to develop a process and heterophasic polymer exhibiting improved optical properties.

### SUMMARY

Embodiments of the present invention include polymer blends. The polymer blends generally include a single site transition metal catalyst formed polypropylene, a single site transition metal catalyst formed polyethylene and a polyethylene compatible nucleator.

One or more embodiments include a method of compatibilizing a blend of polypropylene and polyethylene. The method generally includes blending a polyethylene compatible nucleator with a single site transition metal catalyst formed polypropylene and a single site transition metal catalyst formed polyethylene to form a blend exhibiting improved compatibility over an identical blend in the absence of the nucleator, wherein the improved compatibility is demonstrated by at least a 20% decrease in haze over the identical blend in the absence of nucleator.

In one or more embodiments (in combination with any other embodiment), the single site transition metal catalyst formed polypropylene includes a random copolymer.

In one or more embodiments (in combination with any other embodiment), the random copolymer includes less than 20 wt. % polyethylene.

In one or more embodiments (in combination with any other embodiment), the random copolymer includes less than 10 wt. % polyethylene.

In one or more embodiments (in combination with any other embodiment), the blend includes at least about 60 wt. % polyethylene and less than about 40 wt. % polypropylene.

In one or more embodiments (in combination with any other embodiment), the blend includes at least about 70 wt. % polyethylene and less than about 30 wt. % polypropylene.

In one or more embodiments (in combination with any other embodiment), the blend includes at least about 80 wt. % polyethylene and less than about 20 wt. % polypropylene.

In one or more embodiments (in combination with any other embodiment), the blend exhibits at least a 20% decrease in haze an identical blend in the absence of the nucleator.

In one or more embodiments (in combination with any other embodiment), the blend exhibits at least a 30% decrease in haze an identical blend in the absence of the nucleator.

In one or more embodiments (in combination with any other embodiment), the blend exhibits at least a 40% decrease in haze an identical blend in the absence of the nucleator.

In one or more embodiments (in combination with any other embodiment), the blend exhibits a haze that is within about 30% of a haze value of the polyethylene.

In one or more embodiments (in combination with any other embodiment), the blend exhibits a haze that is within about 20% of a haze value of the polyethylene.

In one or more embodiments (in combination with any other embodiment), the blend exhibits a haze that is within about 10% of a haze value of the polyethylene.

In one or more embodiments (in combination with any other embodiment), the blend is heterophasic.

In one or more embodiments (in combination with any other embodiment), at least one of the single site transition metal catalysts includes a metallocene catalyst.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition skilled persons in the pertinent art have given that term as reflected in printed publications and issued patents at the time of filing. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Further, any ranges include iterative ranges of like magnitude falling within the expressly stated ranges or limitations.

### Catalyst Systems

Catalyst systems useful for polymerizing olefin monomers include any suitable catalyst system. For example, the catalyst system may include chromium based catalyst systems, Ziegler-Natta catalyst systems, single site transition metal catalyst systems including metallocene catalyst systems, or combinations thereof, for example. The catalysts may be activated for subsequent polymerization and may or may not be associated with a support material, for example. A brief discussion of such catalyst systems is included below, but is in no way intended to limit the scope of the invention to such catalysts.

For example, Ziegler-Nana catalyst systems are generally formed from the combination of a metal component (e.g., a catalyst) with one or more additional components, such as a catalyst support, a cocatalyst and/or one or more electron donors, for example.

One or more embodiments of the invention include Ziegler-Natty catalyst systems generally formed by contacting an alkyl magnesium compound with an alcohol to form a magnesium dialkoxide compound and then contacting the magnesium dialkoxide compound with successively stronger chlorinating agents. (See, U.S. Pat. No. 6,734,134 and U.S. Pat. No. 6,174,971, which are incorporated herein by reference.)

Metallocene catalysts may be characterized generally as coordination compounds incorporating one or more cyclopentadienyl (Cp) groups (which may be substituted or unsubstituted, each substitution being the same or different) coordinated with a transition metal through π bonding. The substituent groups on Cp may be linear, branched or cyclic hydrocarbyl radicals, for example. The cyclic hydrocarbyl radicals may further form other contiguous ring structures, including indenyl, azulenyl and fluorenyl groups, for example. These contiguous ring structures may also be substituted or unsubstituted by hydrocarbyl radicals, such as _{C1} to _{C20} hydrocarbyl radicals, for example.

In one or more embodiments, the catalyst system utilized includes single site transition metal catalysts. In one or more specific embodiments, the catalyst systems include metallocene catalysts.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678: U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀) olefin monomers, or C₂ to C₁₂ olefin monomers (e.g., ethylene, propylene, butene, pentene, methylpentene, hexene, octene and decene), for example. The monomers may include olefinic unsaturated monomers, C₄ to C₁₈ diolefins, conjugated or nonconjugated dienes, polyenes, vinyl monomers and cyclic olefins, for example. Non-limiting examples of other monomers may include norbornene, norbornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process with the exception that the liquid medium is also the reactant (e.g., monomer) in a bulk phase process. However; a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen (or other chain terminating agents, for example) may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any suitable method, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

Upon removal from the reactor, the polymer may be passed to a polymer recovery system for further processing, such as addition of additives and/or extrusion, for example.

Embodiments of the invention generally include blending incompatible polymers with one another to form a polymer blend. As used herein, the term “incompatible polymers” refers to polymers that are unable to co-crystallize to form a single crystalline phase (i.e., homophasic polymers), thereby forming heterophasic polymers. For example, in one or more embodiments, the incompatible polymers include a propylene based polymer and an ethylene based polymer.

Embodiments of the invention include contacting the polymer blend with a modifier (i.e., “modification”), which may occur in the polymer recovery system or in another manner known to one skilled in the art. As used herein, the term “modifier” refers to an additive that effectively accelerates phase change from liquid polymer to semi-crystalline polymer (measured by crystallization rates) and may include nucleators, clarifiers and combinations thereof.

Nucleation of homophasic polymers generally improves optical properties of the polymer, such as improved haze and clarity. In contrast, nucleation of heterophasic polymers has not generally improved such optical properties.

However, embodiments of the invention utilize a polyethylene compatible nucleator as the modifier. As used herein, the term “polyethylene compatible nucleator” refers to a modifier capable of accelerating phase change in ethylene based polymers. Unexpectedly, the polyethylene compatible nucleator provides for polymer blends exhibiting significantly improved optical properties. For example, the polymer blends unexpectedly exhibit a decrease in haze of at least about 20%, or at least about 30% or at least about 40% over identical polymer blends in the absence of the polyethylene compatible nucleator. In addition, the polymer blends exhibit a haze that is within at least about 30%, or at least about 20% or at least about 10% of the haze value of the ethylene based polymer absent the propylene based polymer (i.e., not a blend).

The nucleators may include any polyethylene compatible nucleator known to one skilled in the art. For example, non-limiting examples of polyethylene compatible nucleators may include carboxylic acid salts, including sodium benzoate, talc, phosphates, metallic-silicate hydrates, organic derivatives of dibenzylidene sorbitol, sorbitol acetals, organophosphate salts and combinations thereof. In one embodiment, the polyethylene compatible nucleators are selected from Na-11 and Na-21, commercially available from Amfine Chemical, Hyperform HPN-68, HPN-20E, Millad 3988 and Millad 3940, commercially available from Milliken Chemical. In one specific embodiment, the modifier includes Hyperform HPN-20E.

The modifier is blended with the polymer blend in a concentration sufficient to accelerate the phase change of the polymer. In one or more embodiments, the modifier may be used in concentrations of from about 5 to about 3000 ppm, or from about 50 ppm to about 1500 ppm or from about 100 ppm to about 1000 ppm by weight of the polymer, for example.

The modifier may be blended with the polymer blend in any manner known to one skilled in the art. For example, one or more embodiments of the invention include melt blending the ethylene based polymer with the modifier prior to contact with the propylene based polymer. In another embodiment, the modifier contacts the propylene based polymer prior to contact with the ethylene based polymer and in yet another embodiment, the ethylene based polymer contacts the propylene based polymer prior to modification.

Further, it is contemplated that the modifier may be formed into a “masterbatch” (e.g., combined with a concentration of masterbatch polymer, either the same or different from the polymer described above) prior to blending with the polymer. Alternatively, it is contemplated that the modifier may be blended “neat” (e.g., without combination with another chemical) with the polymer.

### Polymer Product

As discussed above, the polymer blends generally include a propylene based polymer and an ethylene based polymer. In one or more embodiments, the propylene based polymer, the ethylene based polymer or combinations thereof are formed by single site transition metal catalysts. For example, the propylene based polymer, the ethylene based polymer or combinations thereof may be formed by metallocene catalysts. Unless otherwise designated herein, all testing methods are the current methods at the time of tiling.

As used herein, the term “ethylene based” is used interchangeably with the terms “ethylene polymer” or “polyethylene” and refers to a polymer having at least about 50 wt. %, or at least about 70 wt. %, or at least about 75 wt. %, or at least about 80 wt. %, or at least about 85 wt. % or at least about 90 wt. % polyethylene relative to the total weight of polymer, for example.

As used herein, the term “propylene based” is used interchangeably with the terms “propylene polymer” or “polypropylene” and refers to a polymer having at least about 50 wt. %, or at least about 70 wt. %, or at least about 75 wt. %, or at least about 80 wt. %, or at least about 85 wt. % or at least about 90 wt. % polypropylene relative to the total weight of polymer, for example.

The polymer blends may include at least about 50 wt. %, or at least about 60 wt. %, or at least about 70 wt. % or at least about 80 wt. % polyethylene.

In one or more embodiments, the polymer blend includes less than about 50 wt. %, or less than about 40 wt. %, or less than about 30 wt. % or less than about 20 wt. % polypropylene.

The ethylene based polymers may have a narrow molecular weight distribution (M_{w}/Mₙ). As used herein, the term “narrow molecular weight distribution” refers to a polymer having a molecular weight distribution of from about 1.5 to about 8, or from about 2.0 to about 7.5 or from about 2.0 to about 6.0, for example.

The ethylene based polymers may have a density (as measured by ASTM D-792) of from about 0.86 g/cc to about 0.98 g/cc, or from about 0.88 g/cc to about 0.97 g/cc, or from about 0.90 g/cc to about 0.965 glee or from about 0.91 g/cc to about 0.95 g/cc, for example.

The ethylene based polymers may have a melt index (MI₂) (as measured by ASTM D-1238) of from about 0.01 dg/min to about 100 dg/min., or from about 0.01 dg/min. to about 25 dg/min., or from about 0.03 dg/min. to about 15 dg/min. or from about 0.05 dg/min. to about 10 dg/min, for example.

In one or more embodiments, the ethylene based polymers include low density polyethylene. In one or more embodiments, the ethylene based polymers include linear low density polyethylene. In another embodiment, the ethylene based polymers include medium density polyethylene. As used herein, the term “medium density polyethylene” refers to ethylene based polymers having a density of from about 0.92 g/cc to about 0.94 g/cc or from about 0.926 g/cc to about 0.94 g/cc, for example.

In one or more embodiments, the ethylene based polymers include high density polyethylene. As used herein, the term “high density polyethylene” refers to ethylene based polymers having a density of from about 0.94 g/cc to about 0.97 g/cc, for example.

The propylene based polymers may have a molecular weight distribution (Mₙ/M_{w}) of from about 1.0 to about 20, or from about 1.5 to about 15 or from about 2 to about 12, for example.

The propylene based polymers may have a melting point (Tₘ) (as measured by DSC) of at least about 110° C. or from about 115° C. to about 175° C., for example.

The propylene based polymers may include about 15 wt. % or less, or about 12 wt. % or less 12, or about 10 wt. % or less, or about 6 wt. % or less, or about 5 wt. % or less or about 4 wt. % or less of xylene soluble material (XS), for example (as measured by ASTM D5492-06).

The propylene based polymers may have a melt flow rate (MFR) (as measured by ASTM D-1238) of from about 0.01 dg/min to about 1000 dg/min., or from about 0.01 dg/min. to about 100 dg/min., for example.

In one or more embodiments, the polymers include polypropylene homopolymers. Unless otherwise specified, the term “polypropylene homopolymer refers to propylene homopolymers or those polymers composed primarily of propylene and amounts of other comonomers, wherein the amount of comonomer is insufficient to change the crystalline nature of the propylene polymer significantly.

In one or more embodiments, the polymers include propylene based random copolymers. Unless otherwise specified, the term “propylene based random copolymer” refers to those copolymers composed primarily of propylene and an amount of at least one comonomer, wherein the polymer includes at least about 0.5 wt. %, or at least about 0.8 wt. %, or at least about 2 wt. %, or from about 0.5 wt. % to about 20.0 wt. %, or from about 0.6 wt. % to about 10.0 wt. % comonomer relative to the total weight of polymer, for example. The comonomers may be selected from C₂ to C₁₀ alkenes. For example, the comonomers may be selected from ethylene, propylene, 1-butene, 1-pentene, 1-hexene; 1-heptene, 1-octene, 1-nonene, 1-decent, 4-methyl-1-pentene and combinations thereof. In one specific embodiment, the comonomer includes ethylene. Further, the term “random copolymer” refers to a copolymer formed of macromolecules in which the probability of finding a given monomeric unit at any given site in the chain is independent of the nature of the adjacent units.

The propylene based random copolymers may exhibit a melt flow rate of at least about 2 dg./10 min., or from about 5 dg./10 min. to about 30 dg./10 min. or from about 10 dg./10 min. to about 20 dg./10 min., for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown, oriented or cast films formed by extrusion or co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include slit-films, monofilaments, melt spinning, solution spinning and melt blown fiber operations for use in woven or non-woven form to make sacks, bags, rope, twine, carpet backing, carpet yarns, filters, diaper fabrics, medical garments and geotextiles, for example. Extruded articles include medical tubing, wire and cable coatings, sheets, such as thermoformed sheets (including profiles and plastic corrugated cardboard), geomembranes and pond liners, for example. Molded articles include single and multi-layered constructions in the form of bottles, tanks, large hollow articles, rigid food containers and toys, for example.

In one or more specific examples, the polymer blend is utilized to form a film.

### Examples

2 mil films were made on a coextrusion blown film line, using a blow up ratio of 2.5. The films had the following composition: Film 1 was formed of Polymer A, Film 2 A/B/A Structure (12/80/8 wt. %). Film 3 A/B/A Structure (12/80/8 wt. %) with 5 wt. % hypernucleator. Polymer A was a commercial metallocene-based polyethylene (density=0.927 g/cc, MI₂=0.9 dg/min). Polymer B was a blend of 85 wt. % of Polymer A and 15 wt. % of a metallocene-based polypropylene random copolymer (MFR=12 dg/min, Tₘ=120° C.) and the hypernucleator was a hypernucleated masterbatch of HL3-4.

It was observed that processing pressures and motor amperes were reduced when blending the propylene based polymer and the ethylene based polymer in the presence of the polyethylene compatible nucleator. See, below in Table 1.

TABLE 1

| | Pressure | Motor Amperes |
|---|---|---|
| | (psi) | (% load) |
| Film 1 | 3055 | 42 |
| Film 2 | 2460 | 34 |
| Film 3 | 2435 | 33 |

While making the films, it was noticed the initial melt was clear in all cases, with the unnucleated blend having slightly more haze than the other two blends. This difference was further magnified once the film solidified (e.g., optical property differences in the unnucleated blend could be discerned with the eye). However, by nucleating the blend with the polyethylene compatible nucleator, it was evident that a much clearer film was made. Unexpectedly, a difference between the clarity of the nucleated blend could not be readily distinguished visually when compared to 100% Polymer A.

The visual observations were quantified by optical property testing, the results of which are shown in Table 2. It was observed that when the propylene based polymer was added to the ethylene based polymer to form the polymer blend (i.e., Film 2), the haze doubled and clarity decreased by 3%. However, by nucleating the blend, the haze matched that of neat Polymer A within testing error and the clarity increased from 95.9% to 98.2%, which is only 0.6% lower than neat Polymer A. By nucleating the PE/PP blend, the optical shortcomings of the blend were eliminated.

TABLE 2

| | Transmit- | Haze | Clarity | Std Dev. | Std Dev. | Std Dev |
|---|---|---|---|---|---|---|
| Mat'l | tance (%) | (%) | (%) | Trans. | Haze | Clarity |
| Film 1 | 93.9 | 13.0 | 98.8 | 0.08 | 0.67 | 0.09 |
| Film 2 | 93.6 | 26.7 | 95.9 | 0.08 | 5.02 | 0.68 |
| Film 3 | 93.6 | 13.7 | 98.2 | 0.12 | 0.98 | 0.2 |

While the foregoing is directed to embodiments of the present invention, other and further embodiments of the invention may be devised without departing from the basic scope thereof and the scope thereof is determined by the claims that follow.

What is claimed is:

1. A polymer blend comprising:
a single site transition metal catalyst formed polypropylene;
a single site transition metal catalyst formed polyethylene; and
a polyethylene compatible nucleator.

2. A method of compatibilizing a blend of polypropylene and polyethylene comprising:
blending a polyethylene compatible nucleator with a single site transition metal catalyst formed polypropylene and a single site transition metal catalyst formed polyethylene to form a blend exhibiting improved compatibility over an identical blend in the absence of the nucleator, wherein the improved compatibility is demonstrated by at least a 20% decrease in haze over the identical blend in the absence of nucleator.

3. The blend of claim 1, wherein the single site transition metal catalyst formed polypropylene comprises a random copolymer.

4. The blend of claim 3, wherein the random copolymer comprises less than 20 wt. % polyethylene.

5. The blend of claim 3, wherein the random copolymer comprises less than 10 wt. % polyethylene.

6. The blend of claim 1, wherein the blend comprises at least about 60 wt. % polyethylene and less than about 40 wt. % polypropylene.

7. The blend of claim 1, wherein the blend comprises at least about 70 wt. % polyethylene and less than about 30 wt. % polypropylene.

8. The blend of claim 1, wherein the blend comprises at least about 80 wt. % polyethylene and less than about 20 wt. % polypropylene.

9. The blend of claim 1, wherein the blend exhibits at least a 20% decrease in haze an identical blend in the absence of the nucleator.

10. The blend of claim 1, wherein the blend exhibits at least a 30% decrease in haze an identical blend in the absence of the nucleator.

11. The blend of claim 1, wherein the blend exhibits at least a 40% decrease in haze an identical blend in the absence of the nucleator.

12. The blend of claim 1, wherein the blend exhibits a haze that is within about 30% of a haze value of the polyethylene.

13. The blend of claim 1, wherein the blend exhibits a haze that is within about 20% of a haze value of the polyethylene.

14. The blend of claim 1, wherein the blend exhibits a haze that is within about 10% of a haze value of the polyethylene.

15. The blend of claim 1, wherein the blend is heterophasic.

16. The blend of claim 1, wherein at least one of the single site transition metal catalysts comprise a metallocene catalyst.
